(19) United States
(12) Patent Application Publication
(10) Pub. No.: US 2025/0257750 A1
(43) Pub. Date: Aug. 14, 2025

(54) Pneumatically Activated Coupled Experimental Retention System

(71) Applicant: NORTHROP GRUMMAN SYSTEMS CORPORATION, FALLS CHURCH, VA (US)

(72) Inventors: Alexander J. Schill, Falls Church, VA (US); Michael C. Santa Ana, Falls Church, VA (US); Patrick Shindo, Falls Church, VA (US); Richard N. Mattea, Falls Church, VA (US); Seth M. Pace, Falls Church, VA (US)

(21) Appl. No.: 18/437,811

(22) Filed: Feb. 9, 2024

(51) Int. Cl. B64C 1/14; F16B 5/02

(52) U.S. Cl. CPC F16B 5/0208

(57) ABSTRACT

A fastening system including a plurality of male fasteners and a plurality of female fasteners, where each one of the male fasteners is configured and positioned to be inserted into one of the female fasteners. An air delivery subsystem configured to deliver air to the male and female fasteners in a manner that simultaneously actuates the plurality of male fasteners and simultaneously actuates the plurality of female fasteners so as to simultaneously couple and decouple the male and female fasteners. In one embodiment, the male fasteners are mounted to an aircraft access panel and the female fasteners are mounted to an aircraft body.

### BACKGROUND

### Field

This disclosure relates generally to a fastener assembly including a male fastener and a female fastener and, more particularly, to a fastener assembly including a male fastener and a female fastener that are pneumatically controlled to secure the fasteners together, where a common pneumatic line simultaneously controls a series of the male fasteners and a common pneumatic line simultaneously controls a series of the female fasteners.

### Discussion of the Related Art

Modern aircraft, both commercial and military, often include a number of access panels that allow maintenance workers and the like to gain access to various aircraft systems and devices. These panels are typically secured to the aircraft body by screws or other fastening devices in a manner so that heads of the screws do not extend beyond the outer mold line (OML) of the body so as to maintain aerodynamic efficiency. Often times many screws are necessary to provide the desired panel closing integrity and reliability. Thus, it is a very labor intensive process to remove the screws to remove the panel and to insert the screws to reattach the panel.

### SUMMARY

The following discussion discloses and describes a fastener assembly including a male fastener and a female fastener that are pneumatically controlled to secure the fasteners together. The male fastener includes a hollow body having a mounting end and an insertion end and defining a chamber therein. The male fastener further includes a slidable piston positioned in the chamber and having a threaded bore facing the insertion end, and a cam shaft having a threaded tip threaded into the threaded bore in the male piston, a wide portion including a recess facing the insertion end and a tapered portion between the threaded tip and the wide portion. The male fastener also includes a port in fluid communication with the chamber between the mounting end and the piston, a plurality of spring-loaded pins slidably extending through pin orifices in the hollow body into the chamber along a radial axis substantially perpendicular to the cam shaft, where each pin includes a nub having a diameter larger than the pin orifice that rides on the cam shaft, and a spring positioned in the recess and against the insertion end. The female fastener includes a hollow body having a mounting end and an open end with a flange and defining a chamber therein. The female fastener further includes a slidable piston positioned in the chamber and having a threaded bore facing the open end, an annular retention collar having a rim at one end and a threaded post at an opposite end that is threaded into the threaded bore in the female piston and extends out of the open end of the hollow body. The female fastener also includes a port in fluid communication with the chamber between the mounting end and the piston, and a spring positioned around the retention collar between the flange and the piston.

Applying air pressure to the port in the male fastener causes the piston and the cam shaft to move towards the insertion end of the hollow body against the bias of the spring, which causes the pin nubs to ride on the cam shaft from the wide portion along the tapered portion to retract the pins into the hollow body to allow the insertion end to be inserted into the retention collar. Applying air pressure to the port in the female fastener causes the piston to move the retention collar farther out of the hollow body against the bias of the spring. Insertion of the insertion end of the male fastener into the retention collar with the pins retracted allows the pins to then be extended and positioned under the rim under the bias of the spring when air pressure is removed from the port and then allows the rim to engage the pins and pull the pins and thus the male fastener towards the hollow body of the female fastener under the bias of the spring when air pressure is removed from the port in the female fastener.

Additional features of the disclosure will become apparent from the following description and appended claims, taken in conjunction with the accompanying drawings.

### BRIEF DESCRIPTION OF THE DRAWINGS

FIG. 1 is a broken-away view of an aircraft showing an access panel at an underside location of the aircraft fuselage;

FIG. 2 is an isometric view of a fastener assembly including a male fastener and a female fastener;

FIGS. 3-6 are cross-sectional type isometric views of the fastener assembly in various stages of coupling between the male and female fasteners;

FIG. 7 is an isometric view of an aircraft access panel including a fastening system made up of a series of the male fasteners interconnected by a common pneumatic line; and

FIG. 8 is an isometric view of an aircraft body including a fastening system made up of a series of the female fasteners interconnected by a common pneumatic line.

### DETAILED DESCRIPTION OF THE EMBODIMENTS

The following discussion of the embodiments of the disclosure directed to a fastener assembly including a male fastener and a female fastener that are pneumatically controlled to secure the fasteners together is merely exemplary in nature, and is in no way intended to limit the disclosure or its applications or uses. For example, the discussion herein describes the fastening system as having application for fastening an access panel to an aircraft body. However, as will be appreciated by those skilled in the art, the fastening system will have other applications.

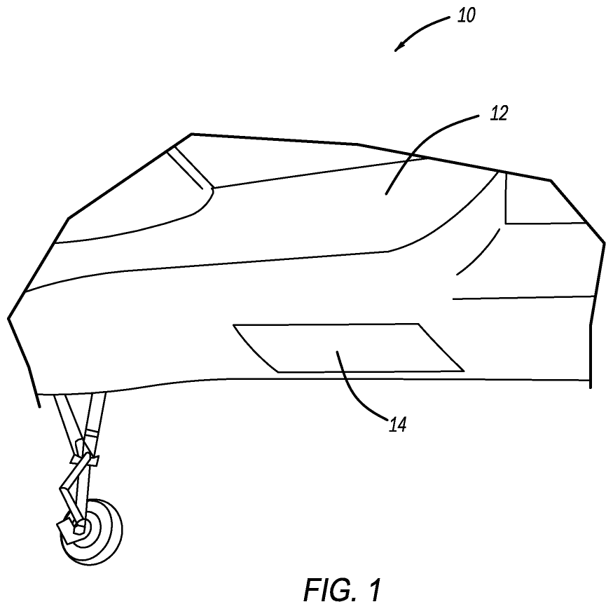

FIG. 1 is a broken-away view of an aircraft 10 including a fuselage 12 having an access panel 14 mounted to an underside of the fuselage 12. As will be discussed in detail below, the access panel 14 can be secured to the fuselage 14 by a pneumatically activated mechanical fastening system.

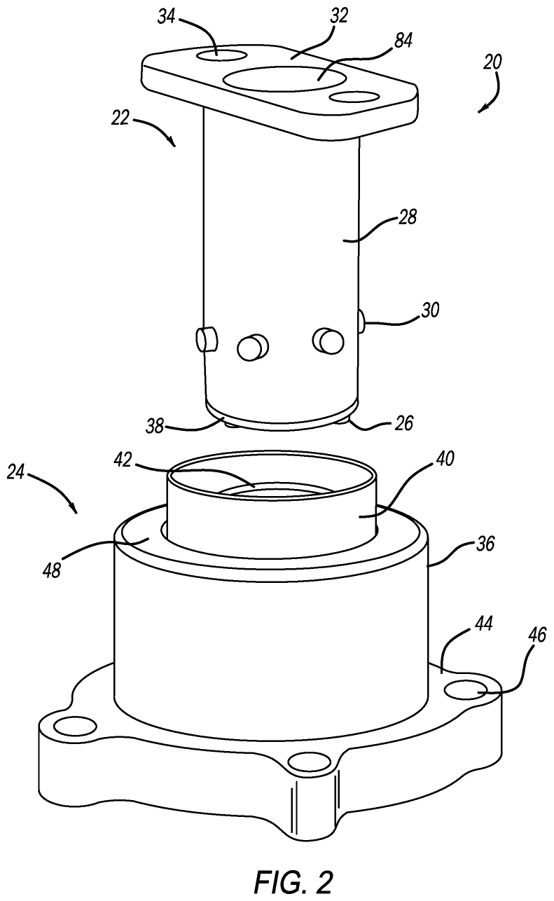

FIG. 2 is an isometric view of a fastener assembly 20 that is part of the fastening system referred to above. The fastener assembly 20 includes a male fastener 22 and a female fastener 24, where the male fastener 22 may be mounted to the access panel 14 and the female fastener 24 may be mounted to the fuselage 12 in this non-limiting example. The male fasteners 22 are all attached under the OML of the aircraft 10, and thus the exposure of the male fasteners 22 to the OML of the aircraft 10 is reduced, which has aero and other technical advantages. The male fastener 22 includes a cylindrical hollow body 28 made of, for example, stainless steel and having an endcap 38 secured to an end of the body 28 with bolts 26. A series of spring-loaded pins 30, here six, are symmetrically disposed around an end of the body 28 proximate the endcap 38 on a common plane and a mounting plate 32 including bolt holes 34 is formed to an opposite end of the body 28. The female fastener 24 includes a cylindrical hollow body 36 made of, for example, stainless steel that is open at a top end to accept the body 28 of the male fastener 22. A retention collar 40 including an angled or undercut rim 42 is disposed within the body 36 of the female fastener 24 and partially extends therefrom through an annular flange 48. The female fastener 24 also includes a mounting plate 44 having bolt holes 46 formed to a bottom end of the body 36.

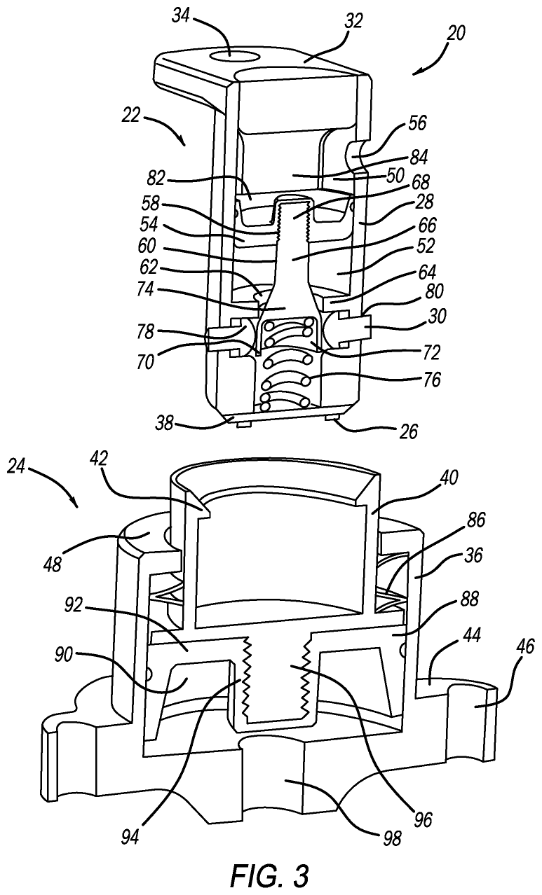

FIGS. 3-6 are cross-sectional type isometric views of the fastener assembly 20 shown in various stages of coupling. FIG. 3 shows the male fastener 22 and the female fastener 24 separated from each other as shown in FIG. 2 in a state where the access panel 14 is ready to be coupled to the fuselage 12.

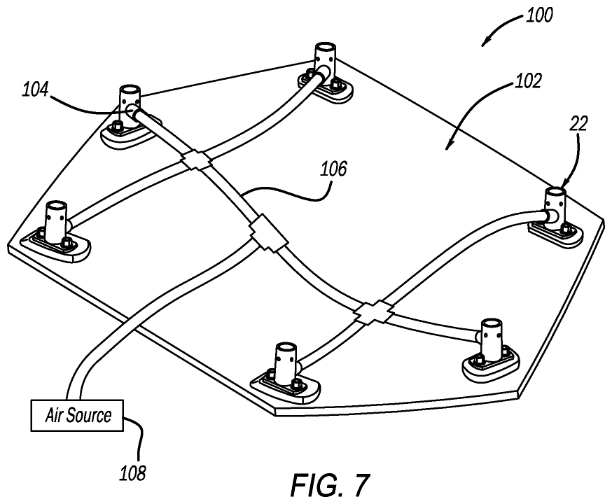

The body 28 of the male fastener 22 includes a chamber 50 at the bottom end of the body 28 and a chamber 52 at the top end of the body 28 that are separated by a slidable piston 54 having a threaded bore 58 facing the chamber 52. In one non-limiting embodiment, the piston 54 is made of Delrin or acytel resin and has a flexible skirt 82 that is forced outward against the inside walls of the body 28 as air pressure increases. A threaded port 56 extends through the body 28 to be in fluid communication with the chamber 50, and allows for commercial off the shelf (COTS) pneumatic fittings to be secured thereto. A cam shaft 60 extends through the chamber 52 and through a center opening 62 of an annular pin guide 64. The cam shaft 60 includes a narrow diameter cylindrical portion 66 having a threaded tip 68 that is threaded into the bore 58 in the piston 54, a wide diameter cylindrical portion 70 including an annular recess 72 and a tapered portion 74 therebetween. A spring 76 is positioned in the recess 72 and against the endcap 38. A plug 84 is inserted through the plate 32 and into the chamber 50 and operates as a stop to prevent the piston 54 from pressing into an air fitting (see FIG. 7) that is threaded into the port 56. The pins 30 extend into the chamber 52 along a radial axis substantially perpendicular to the cam shaft 60 and include an end nub 78 that rides along the cam shaft 60 when the piston 54 moves. The pins 30 extend through pin orifices 80 that are sized so that the nub 78 is unable to pass through.

The body 36 of the female fastener 24 includes a chamber 90. A piston 92 is positioned within the chamber 90 and includes a threaded bore 94. In one non-limiting embodiment, the piston 92 is made of Delrin or acytel resin and has a flexible skirt 88 that is forced outward against the inside walls of the body 36 as air pressure increases. The retention collar 40 includes a threaded post 96 that is threaded into the bore 94 in the piston 92 to secure the collar 40 thereto. A spring 86 is positioned in the chamber 90 between the piston 92 and the flange 48 and encircles the collar 40. A threaded port 98 extends through the mounting plate 44 and is in fluid communication with the chamber 90, and allows for COTS pneumatic fittings to be secured thereto.

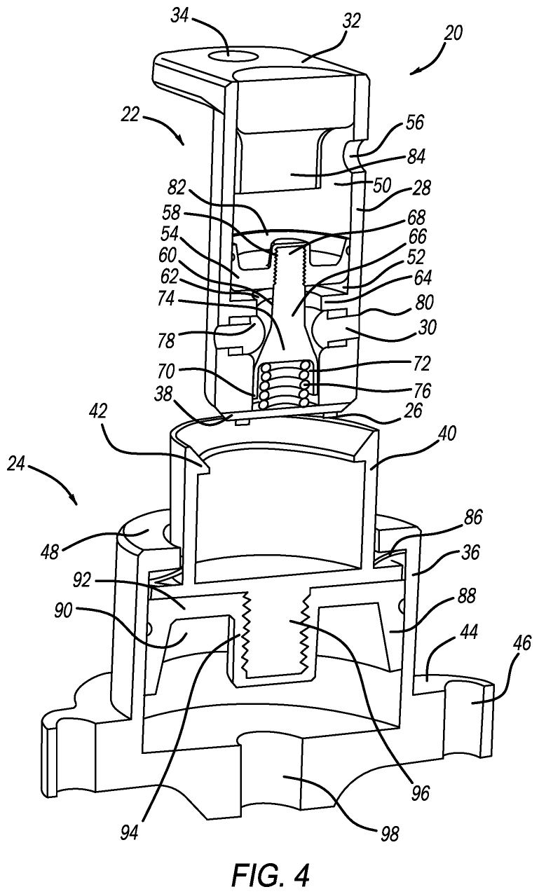

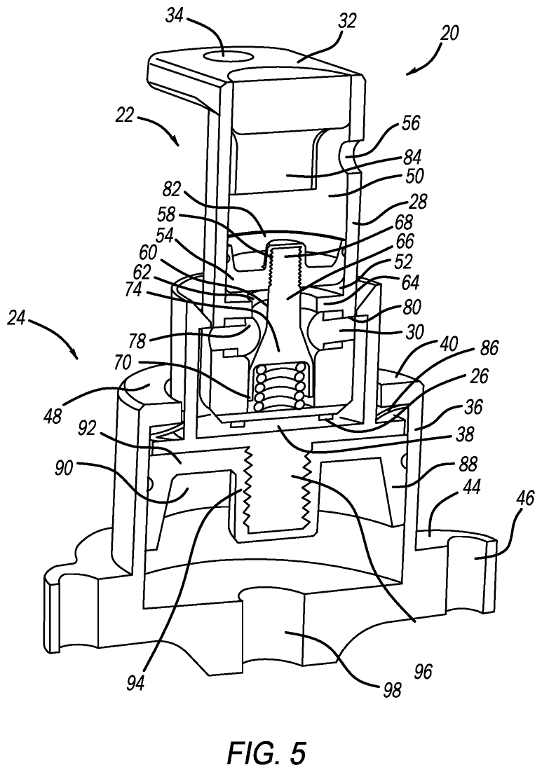

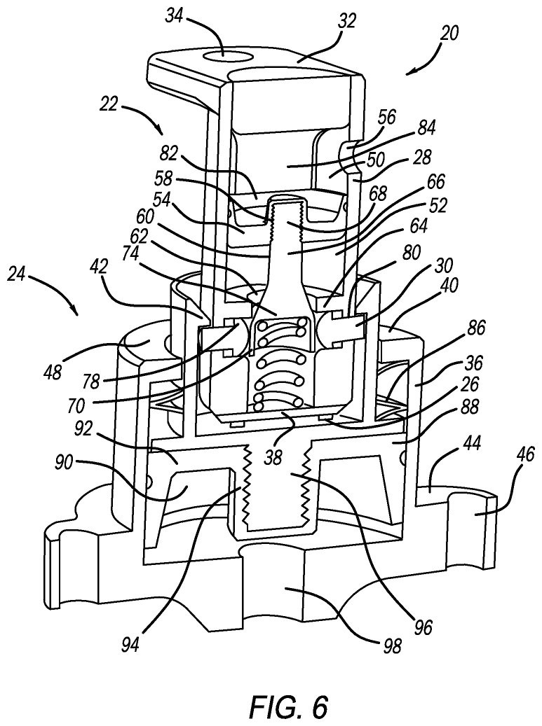

The following procedure is followed to couple the male fastener 22 to the female fastener 24. When the fastener assembly 20 is in the state shown in FIG. 3, air pressure is applied to the port 56 and into the chamber 50, which causes the piston 54 and the cam shaft 60 to be pushed down against the bias of the spring 76. As the shaft 60 moves, the nubs 78 ride along the tapered portion 74 of the shaft 60 so that the spring loaded pins 30 retract into the body 28. At or about the same time, air pressure is applied to the port 98, which causes the piston 92 to move up against the bias of the spring 86 and extend the retention collar 40 further out of the body 36. This position of the fastener assembly 20 is shown in FIG. 4. The body 28 of the male fastener 22 is then inserted into the retention collar 40, manually or otherwise, far enough so that the retracted pins 30 are below the rim 42 of the retention collar 40. The air pressure being applied to the port 56 is released, which causes the shaft 60 to rise under the bias of the spring 76, which cause the pins 30 to be pushed out of the orifices 80 against their spring-loaded bias and be positioned under the rim 42. This position of the fastener assembly 20 is shown in FIG. 5. The air pressure is then released from the port 98, which causes the spring 86 to push the piston 92 down, which causes the rim 42 to engage the pins 30 and pull the male fastener 22 down and lock the fasteners 22 and 24 together. This position of the fastener assembly 20 is shown in FIG. 6. The fastener assembly 20 is in the locked position with no air pressure being applied to the ports 56 and 98, and thus is in a fail safe mode. The process to decouple the male fastener 22 from the female fastener 24 is accomplished in the reverse order, as described.

FIG. 7 is an isometric view of an aircraft access panel 100, representing the panel 14, including a fastening system 102 having a series of the male fasteners 22 bolted to the panel 100, where suitable fittings 104 are coupled to the ports 56 and a common pneumatic line 106 is coupled to the fittings 104 and a single air source 108.

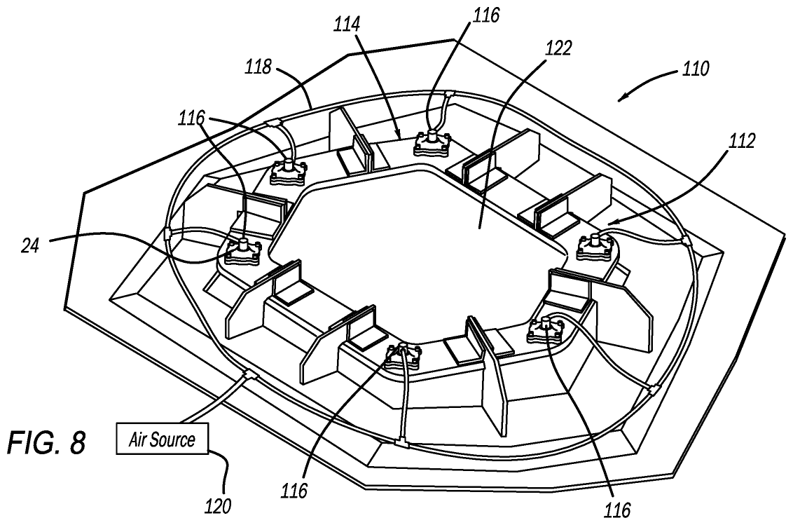

Likewise, FIG. 8 is an isometric view of a portion of an aircraft body 110 illustrating a fastening system 112 coupled to the body 110 by a support structure 114 surrounding an opening 122. The fastening system 112 includes a series of the female fasteners 24 bolted to the support structure 114, where suitable fittings 116 are coupled to the ports 98 and a common pneumatic line 118 is coupled to the fittings 116 and a single air source 120.

Air from the source 108 is simultaneously provided to the fasteners 22 and air from the source 120 is simultaneously provided to the fasteners 24 in the manner described above to connect and disconnect the fasteners 22 and 24. When attaching the fasteners 22 and 24, a worker will manually position the panel 100 in the opening 122 in the body 110 so that the fasteners 22 and 24 align for the step shown in FIG. 5.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A fastening assembly comprising:
a male fastener including a hollow cylindrical male body having a mounting male end and an insertion end and defining a male chamber therein, said male fastener further including a slidable male piston positioned in the male chamber and having a threaded male bore facing the insertion end, a cam shaft having a threaded tip threaded into the threaded male bore in the male piston, a wide portion including a recess facing the insertion end and a tapered portion between the threaded tip and the wide portion, a male port in fluid communication with the male chamber between the mounting male end and the male piston, a plurality of spring-loaded pins slidably extending through pin orifices in the hollow male body into the male chamber along a radial axis substantially perpendicular to the cam shaft, where each pin includes a nub having a diameter larger than the pin orifice that rides on the cam shaft, and a male spring positioned in the recess and against the insertion end; and
a female fastener including a hollow cylindrical female body having a mounting female end and an open end with a flange and defining a female chamber therein, said female fastener further including a slidable female piston positioned in the female chamber and having a threaded female bore facing the open end, an annular retention collar having a rim at one end and a threaded post at an opposite end that is threaded into the threaded female bore in the female piston and extends out of the open end of the hollow female body, a female port in fluid communication with the female chamber between the mounting female end and the female piston, and a female spring positioned around the retention collar between the flange and the female piston, wherein applying air pressure to the male port causes the male piston and the cam shaft to move towards the insertion end of the hollow male body against the bias of the male spring, which causes the pin nubs to ride on the cam shaft from the wide portion along the tapered portion to retract the pins into the hollow male body to allow the insertion end to be inserted into the retention collar, and wherein applying air pressure to the female port causes the female piston to move the retention collar farther out of the hollow female body against the bias of the female spring, and wherein insertion of the insertion end into the retention collar with the pins retracted allows the pins to then be extended and positioned under the rim under the bias of the male spring when air pressure is removed from the male port and then allows the rim to engage the pins and pull the pins and thus the male fastener towards the hollow female body under the bias of the female spring when air pressure is removed from the female port.

2. The fastener assembly according to claim 1 wherein the plurality of pins is six pins.

3. The fastener assembly according to claim 1 wherein the mounting male and female ends include a mounting plate having bolt holes.

4. The fastener assembly according to claim 1 wherein the male fastener further includes an annular pin guide positioned in the male chamber proximate the pins, said cam shaft extending through a central opening in the annular pin guide.

5. The fastener assembly according to claim 1 wherein the male fastener is configured to be mounted to an access panel on an aircraft and the female fastener is configured to be mounted to a fuselage on the aircraft.

6. A fastening system comprising:
a plurality of male fasteners each including a hollow body having a mounting end and an insertion end and defining a chamber therein, each male fastener further including a slidable piston positioned in the chamber and having a threaded bore facing the insertion end, a cam shaft having a threaded tip threaded into the threaded bore in the piston, a wide portion including a recess facing the insertion end and a tapered portion between the threaded tip and the wide portion, a port in fluid communication with the chamber between the mounting end and the piston, a plurality of spring-loaded pins slidably extending through pin orifices in the hollow body into the chamber along a radial axis substantially perpendicular to the cam shaft, where each pin includes a nub having a diameter larger than the pin orifice that rides on the cam shaft, and a spring positioned in the recess and against the insertion end; and
an air delivery subsystem including an air fitting coupled to each port, at least one air hose coupled to the air fittings and an air source coupled to the at least one air hose, wherein applying air pressure from the air source to the at least one air hose and to each of the air fittings simultaneously causes in each of the male fasteners the piston and the cam shaft to move towards the insertion end of the hollow body against the bias of the spring, which causes the pin nubs to ride on the cam shaft from the wide portion along the tapered portion to retract the pins into the hollow body.

7. The fastening system according to claim 6 wherein the plurality of pins is six pins.

8. The fastening system according to claim 6 wherein the mounting end includes a mounting plate having bolt holes.

9. The fastening system according to claim 6 wherein the male fastener further includes an annular pin guide positioned in the chamber proximate the pins, said cam shaft extending through a central opening in the annular pin guide.

10. The fastening system according to claim 6 wherein the male fastener is configured to be mounted to an access panel on an aircraft.

11. A fastening system comprising:
a plurality of female fasteners each including a hollow body having a mounting end and an open end with a flange and defining a chamber therein, each female fastener further including a slidable piston positioned in the chamber and having a threaded bore facing the open end, an annular retention collar having a rim at one end and a threaded post at an opposite end that is threaded into the threaded bore in the piston and extends out of the open end of the hollow body, a port in fluid communication with the chamber between the mounting end and the piston, and a spring positioned around the retention collar between the flange and the piston; and
an air delivery subsystem including an air fitting coupled to each port, at least one air hose coupled to the air fittings and an air source coupled to the at least one air hose, wherein applying air pressure from the air source to the at least one air hose and to each of the air fittings simultaneously causes in each of the female fasteners the piston to move the retention collar farther out of the hollow body against the bias of the spring.

12. The fastening system according to claim 11 wherein the mounting end includes a mounting plate having bolt holes.

13. The fastening system according to claim 11 wherein the female fastener is configured to be mounted to an aircraft fuselage.

14. A fastening system comprising:
a plurality of male fasteners each including a hollow male body having a mounting male end and an insertion end and a male port in fluid communication with the hollow male body;
a male air delivery subsystem including a male air fitting coupled to each male port, at least one male air hose coupled to the male air fittings and a male air source coupled to the at least one male air hose, wherein applying air pressure from the male air source to the at least one male air hose and to each of the air fittings simultaneously actuates the plurality of male fasteners;
a plurality of female fasteners each including a hollow female body having a mounting female end and an open end and a female port in fluid communication with the hollow female body; and
a female air delivery subsystem including a female air fitting coupled to each female port, at least one female air hose coupled to the female air fittings and a female air source coupled to the at least one female air hose, wherein applying air pressure from the female air source to the at least one female air hose and to each of the female air fittings simultaneously actuates each of the female fasteners.

15. The fastening system according to claim 14 wherein each male fastener further includes a slidable piston positioned in the hollow male body and having a threaded bore facing the insertion end, a cam shaft having a threaded tip threaded into the threaded bore in the piston, a wide portion including a recess facing the insertion end and a tapered portion between the threaded tip and the wide portion, a plurality of spring-loaded pins slidably extending through pin orifices in the hollow body into the hollow male body along a radial axis substantially perpendicular to the cam shaft, where each pin includes a nub having a diameter larger than the pin orifice that rides on the cam shaft, and a spring positioned in the recess and against the insertion end.

16. The fastening system according to claim 15 wherein the plurality of pins is six pins.

17. The fastening system according to claim 15 wherein each male fastener further includes an annular pin guide positioned in the chamber proximate the pins, said cam shaft extending through a central opening in the annular pin guide.

18. The fastening system according to claim 14 wherein each female fastener further includes a slidable piston positioned in the hollow female body and having a threaded bore facing the open end, an annular retention collar having a rim at one end and a threaded post at an opposite end that is threaded into the threaded bore in the piston and extends out of the open end of the hollow female body, and a spring positioned around the retention collar.

19. The fastener system according to claim 14 wherein the mounting male and female ends include a mounting plate having bolt holes.

20. The fastener system according to claim 14 wherein the male fasteners are configured to be mounted to an access panel on an aircraft and the female fasteners are configured to be mounted to a fuselage on the aircraft.
